(19) United States
(12) Patent Application Publication
(10) Pub. No.: US 2009/0011284 A1
(43) Pub. Date: Jan. 8, 2009

(54) Core Composite Film for a Magnetic/Nonmagnetic/Magnetic Multilayer Thin Film and Its Useage

(76) Inventors: Tianxing Wang, Beijing (CN); Zhongming Zeng, Beijing (CN); Guanxiang Du, Beijing (CN); Xiufeng Han, Beijing (CN); Zhenmin Hong, Beijing (CN); Gauquan Shi, Beijing (CN)

Correspondence Address: GROOVER & Associates, BOX 802889, DALLAS, TX, 75380-2889, US

(21) Appl. No.: 11/909,553

(22) PCT Filed: Mar. 24, 2006
(86) PCT No.: PCT/CN2006/000486

§ 371 Date: May 20, 2008

(30) Foreign Application Priority Data
Mar. 24, 2005 (CN) 200510056941.8

(51) Int. Cl. G11B 5/706

(52) U.S. Cl. 428/847.2; 428/846; 428/847.1

(57) ABSTRACT

The present invention relates to a core composite film for magnetic/nonmagnetic/magnetic multilayer thin film comprising a free magnetic layer, a spacer layer and a pinned magnetic layer. As the core composite film, it may be only the spacer layer is an LB film; and the spacer layer is an organic LB film consisting of materials with insulative, conductive or semiconductive character. As the core composite film, it may also be said free magnetic layer, spacer layer and pinned magnetic layer are all LB films; wherein the pinned magnetic layer and the free magnetic layer are organic films made of magnetic materials. The core composite film can be applied to a magnetic spin valve sensor, which can compose a magnetic induction unit of a magnetic spin valve sensor; and it can also be applied to a magnetic random access memory as a memory cell. Uniformity and consistency can be kept over large areas for the core composite film, and the process thereof is simple and the cost is low; moreover, by use of an LB organic film substituting for conventional spacer layer and magnetic layer, devices are made lighter, thinner, easier to be processed to and integrated.

### TECHNICAL FIELD

The present invention relates to materials field, in particular, the present invention relates to a core composite film for magnetic/nonmagnetic/magnetic multilayer thin film, more particularly, to a core composite film with an LB-film structure which has the giant magnetoresistance effect or the tunneling magnetoresistance effect, and its usage in spin valve sensor and magnetic random access memory.

### BACKGROUND ART

As a magnetic induction unit of a magnetic spin valve sensor or a memory cell of a magnetic random access memory (hereinafter referred as MRAM), it comprises three to tens of layers of magnetic and nonmagnetic thin film, wherein the magnetic and nonmagnetic multilayer thin film at least contains such a core composite film which has a similar three-layer “sandwich” structure: a pinned magnetic layer/a spacer layer/a free magnetic layer (shown in FIG. 1). Wherein, the spacer layer is of a nonmagnetic material, being located between two magnetic material layers, and its thickness is very small, commonly between 0.5 nm and 5.0 nm. The magnetization direction of one and only one layer of the two magnetic material layers is pinned by outside certain or several layers of the materials, which is called “a pinned magnetic layer” and its magnetization direction can not be changed freely by a small external magnetic field. Another layer of the two magnetic material layers is a free magnetic layer, and its magnetization direction can be changed by a small external magnetic field. With the utilization of such core composite film as a memory cell, when the magnetization directions of both magnetic material layers are same, the memory cell presents low-resistance state; while the magnetization directions of both magnetic material layers are opposite, the memory cell presents a high-resistance state. When the magnetization directions of both magnetic material layers form a certain angle, for example, 90 degree, the magnetoresistance value of the cell presents a certain function relationship with an external magnetic field, which may be a scale for magnetic field or magnetic gradient. Therefore, the memory cell has two stable resistance states, which may be used to store information by changing the magnetization direction of the free magnetic layer relative to the pinned magnetic layer in the memory cell; and the stored information may be accessed by detecting the resistance states of the memory cell.

In a conventional core composite film for magnetic/nonmagnetic/magnetic multilayer thin film, typically, both magnetic layers are made of the materials which include magnetic metals, such as Fe, Co, Ni, etc. and their alloys, magnetic semiconductor materials, half-metallic materials, etc. Pinning magnetic layer typically consists of antiferromagnetic materials, such as Fe—Mn, Ni—Mn, Pt—Mn, Ir—Mn, PtCr, CoO, NiO, etc., or multilayer film composite pinnned materials (for example: Co/Ru/Co, Co/Cu/Co, etc.). The thicknesses of the free magnetic layer and the pinned magnetic layer may be varied dependent on requirements, and artificial pinning method may be used also. Metallic conductive materials such as Cu, Cr, Ru, etc., or insulative (barrier) materials, or semi-insulative materials are typically used to form a spacer layer. For example, for spin-valve type giant magnetoresistance (GMR) multilayer film, metallic conductive materials are used to form a spacer layer; for magnetoresistive heterojunction materials, semiconductor materials are used to form a spacer layer; and for a magnetic tunnel junction (MTJ), insulative materials are used to form a spacer layer.

The quality of a spacer layer is a key factor which influences the device performance. For instance, the key factor of affecting the performance of a magnetic tunnel junction is the quality of the barrier layer (i.e., spacer layer), and the quality of the barrier layer directly influence the amount of tunnel junction magnetoresistance ratio (TMR) and the amount of the resistance-area product (RA), while these two indices are closely correlated to whether MTJ can be applied to a magnetic tunnel junction spin valve sensor and the memory cell of a MRAM.

At present, for the fabrication of a magnetoresistive sensor and a magnetic tunnel junction memory cell of MRAM, metal oxides Al₂O₃, MgO and the like, are more frequently used as the materials of a barrier layer, and it is very difficult to keep uniformity and consistency over large area for the barrier layer with about 1 nm in thickness prepared by conventional methods, leading to low product rate and high cost, and thus restricting the development and manufacture of magnetoresistive sensors and MRAM. In order to solve this problem, large investment and bucky advanced production facilities are in need to manufacture high-quality ultrathin barrier layers of metal oxides over large area in the production and processing.

Langmuir-Blodgett (LB) technique is one of advanced techniques for preparing well-ordered molecular ultrathin film in a molecular level, of which the process is simple and the cost is low, and the high-quality molecular films with good uniformity and consistency can be fabricated over large area. LB technique enables people to perform the designed and multi-hierarchical arrangements and combinations of molecules to form thickness-controllable and well-ordered thin films, and construct various molecular devices further.

### DISCLOSURE OF THE INVENTION

An object of the present invention is to overcome the following defects of a core composite film for magnetic/nonmagnetic/magnetic multilayer thin film prepared by conventional techniques: being very difficult to keep uniformity and consistency over large area, low rate of finished product and high cost, thereby to provide a core composite film for magnetic/nonmagnetic/magnetic multilayer thin film of which uniformity and consistency can be kept over large area.

The object of the present invention is achieved by the following technical solutions:

The present invention provides a core composite film for magnetic/nonmagnetic/magnetic multilayer thin film, which comprises a free magnetic layer, a spacer layer and a pinned magnetic layer, and said spacer layer is a film prepared by LB technique (hereinafter referred as LB film).

The LB film is prepared on the surface of the pinned magnetic layer by vertical lifting method, horizontal adhesion method, subphase lowering method, monolayer sweep method or diffusion-adsorption method. According to the characteristics of the desired device, the LB film may be one-component monolayer or multilayer or multifunctional hybrid multi-component monolayer or multilayer.

The materials used in said LB film of the spacer layer may be organic materials which possess insulative, conductive or semiconductive characteristics as needed.

Said insulative materials comprise stearic acid (C₁₇H₃₅COOH), ferrum hydroxyl distearate, silver stearate, leuco cyanine stearate, coumarin stearate, acidic ferrum stearate, octadecenoic acid and cetyl trimethyl ammonium bromide.

Said insulative materials comprise: fatty alcohol (CₙH₂ₙ₊₁OH), fatty ester (CₙH₂ₙ₊₁COOR), fatty acid amide (CₙH₂ₙ₊₁CONH₂), fatty alkyl nitrile (CₙH₂ₙ₊₁C≡N) or fatty acid CF₃(CF₂)₇(CH₂)ₙCOOH, wherein n=2, 4, or 6.

Said insulative materials further comprise simply substituted aromatic compounds and functional complexes, where said simply substituted aromatic compounds include p-substituted benzene derivatives R—C₆H₆—X, wherein R is C₁₈H₃₇, C₁₆H₃₃, C₁₄H₂₉, OC₁₈H₃₇, or NHC₁₈H₃₇; X is NH₂, OH, COOH, NHNO₂; and said functional complexes include β-diketone rare earth complex, diazafluoren-one, 8-hydroxyquinoline, copper o-phthalonitrile, bilirubin, heme, and lipoic acid ester.

Said insulative materials further comprise amphiphilic polymers such as polyethylene family ([—CH₂—CH₂—]ₙ), polypropylene family: (C₃H₆)ₙ, polymethacrylate family, polybutadiene family, polyvinyl acetate family, etc., and non-amphiphilic polymers such as poly(3-alkylthiophene) and polyimide.

Said insulative materials further comprise fullerene, porphyrin, or phthalocyanine-like compound and lecithin-like compound, pigment, peptide and protein; said lecithin-like compound is phosphatidyl ethanolamine or phosphatidylcholine; said pigment is iron porphyrin, chlorophyllous pigment, or carotenoid; said other biomolecules include purple membrane and soya bean lecithin.

Said conductive materials comprise charge transfer compound with amphiphilic character, amphiphilic conjugated polymer based on polypyrrole framework, polythiophene or polyacetylene; said charge transfer compound with amphiphilic character includes TTF (tetrathiafulvalene)-TCNQ(7,7′,8,8′-tetracyanoquinodimethane), (TMTSF)₂(PF)₂ and transition metal complex M(dmit)₂(M=Ni, Pb, Pt, Au); said polythiophene is poly(3-hexylthiophene) or poly(3-octylthiophene).

Said semiconductive materials comprise TiO₂/fluorescein, SnO₂/arachidic acid, or doped ZnS.

The present invention provides a method to prepare said core composite film for magnetic/nonmagnetic/magnetic multilayer thin film, with only the middle spacer layer (functional layer) being an LB organic ultrathin film, including the following steps:

First, bottom layers are grown in a high vacuum environment by conventional methods such as magnetron sputtering, electron-beam evaporation, molecular beam epitaxy, pulsed laser deposition, ion-beam assisted deposition or chemical vapor deposition, etc., wherein the bottom layers include a seed layer/a conductive layer/a buffer layer/an antiferromagnetic pinning layer/a pinned magnetic layer; then a high polymer organic LB film is prepared as a spacer layer in a ultraclean environment by vertical lifting method, horizontal adhesion method, subphase lowering method, monolayer sweep method or diffusion-adsorption method; finally, top layers, a free magnetic layer/a buffer layer/a conductive layer/a protecting layer, etc., are grown in a high vacuum environment by conventional methods such as magnetron sputtering, electron-beam evaporation, molecular beam epitaxy, pulsed laser deposition, ion-beam assisted deposition or chemical vapor deposition, etc.

After the sample has been grown, a desired sample unit in certain shape and size is obtained by ultraviolet exposure or electron beam exposure with ion-beam etching, and the unit of the composite magnetic multilayer film can be applied to a device unit of magnetic-sensitive, electro-sensitive, light-sensitive or gas-sensitive sensors or a memory cell of a MRAM.

When said core composite film with only the middle spacer layer (functional layer) being an LB organic ultrathin film is applied to a magnetic/nonmagnetic/magnetic multilayer thin film, said core composite film may be repeated several times, from 2 to a desired number. It can be obtained by repeating the above-mentioned method. For example, a typical structure is: a seed layer/a conductive layer/a buffer layer/an antiferromagnetic pinning layer/[a pinned magnetic layer/LB-film spacer layer/free magnetic layer]ₙ/a buffer layer/a conductive layer/a protecting layer, wherein n=2, 3, 4, . . . .

The present invention provides another kind of core composite film for magnetic/nonmagnetic/magnetic multilayer thin film, whose core structure comprises a free magnetic layer, a spacer layer and a pinned magnetic layer, and all of said free magnetic layer, spacer layer and pinned magnetic layer are LB films; wherein the LB films of the pinned magnetic layer and the free magnetic layer are organic films made of magnetic materials; and the LB film of the spacer layer is organic film consisting of insulative, conductive or semiconductive materials.

Said magnetic materials comprise manganese stearate, ferrocene, or γ-Fe₂O₃ ultrafine powder/stearic acid.

Said insulative, conductive or semiconductive materials of the LB film of the spacer layer are the same as above-mentioned.

The present invention provides a method to prepare said core composite film for magnetic/nonmagnetic/magnetic multilayer thin film, wherein the said core composite film is of sandwich-structure in which each layer is an organic ultrathin film prepared by LB technique, the said method includes the following steps:

First, a seed layer/a conductive layer/a buffer layer/an antiferromagnetic pinning layer are deposited or grown on a substrate in a high vacuum environment by conventional methods such as magnetron sputtering, electron-beam evaporation, molecular beam epitaxy, pulsed laser deposition, ion-beam assisted deposition, chemical vapor deposition, etc.; then the high polymer organic LB films are prepared as a pinned magnetic layer, a spacer layer and a free magnetic layer respectively in a ultraclean environment by vertical lifting method, horizontal adhesion method, subphase lowering method, monolayer sweep method or diffusion-adsorption method; finally, upper multilayer film electrode is deposited and grown in a high vacuum environment by conventional methods such as magnetron sputtering, electron-beam evaporation, molecular beam epitaxy, pulsed laser deposition, ion-beam assisted deposition or chemical vapor deposition, etc., whose structure is: a buffer layer/a conductive layer/a protecting layer.

After the sample has been grown, a desired sample unit in certain shape and size is obtained by ultraviolet exposure or electron beam exposure with ion-beam etching, and the unit of the composite magnetic multilayer film can be applied to a device unit of magnetic-sensitive, electro-sensitive, light-sensitive or gas-sensitive sensors or a memory cell of a MRAM; or is used to produce the desired functional units directly by self-adaptive, self-assembly technique, and to fabricate the sensor units and memory cells.

When said core composite film with core sandwich-structure being LB organic ultrathin films is applied to a magnetic/nonmagnetic/magnetic multilayer thin film, it may be repeated several times, from 2 to a desired number. It can be obtained by repeating the above-mentioned method. For example, its typical structure is: a seed layer/a conductive layer/a buffer layer/an antiferromagnetic pinning layer/a pinned magnetic layer/[an LB-film spacer layer/a free magnetic layer]ₙ/a buffer layer/a conductive layer/a protecting layer, wherein n=2, 3, 4, . . . .

For said core composite film for magnetic/nonmagnetic/magnetic multilayer thin film, the present invention provides its use in a magnetic spin valve sensor, that is making magnetic induction unit of a magnetic spin valve sensor. The core layer of the magnetic induction unit is a core composite film for magnetic/nonmagnetic/magnetic multilayer thin film provided by the present invention, whose spacer layer consists of well-ordered conductive or insulative organic ultrathin film (LB film), and the directions of the easy axises of the free magnetic layer and the pinned magnetic layer are perpendicular to each other or form an angle according to the requirements of device performance. Four identical magnetic induction units compose a Wheatstone bridge so as to improve the sensitivity.

For said core composite film for magnetic/nonmagnetic/magnetic multilayer thin film, the present invention provides its use in a MRAM, that is using it as a memory cell of a MRAM. The memory cell comprises a magnetic thin-film storage unit, and the core layer thereof is the core composite film with “sandwich-structure” for magnetic/nonmagnetic/magnetic multilayer thin film provided by the present invention, which consists of two layers of magnetic materials and an LB-film spacer layer located between the two magnetic layers. By use of two magnetization states of the free magnetic layer, i.e. the magnetization direction is parallel or antiparallel to that of the pinned magnetic layer, the information is recorded and stored.

Compared with the prior art, the advantages of the present invention lie in that:

1. In the present invention, LB-film technique is used to prepare each layer of a core composite film for magnetic/nonmagnetic/magnetic multilayer thin film, enabling fabrications of high-quality molecular films with good uniformity and consistency over large area, moreover, the process thereof is simple and the cost is low.
2. In the present invention, regular spin electronic materials are combined with organic materials to prepare magnetoresistive sensors, not only having the characteristics of regular magnetoresistive sensors such as electro-sensitivity and magnetic-sensitivity, but also being possible to implement the functions of light-sensitivity such as light-emitting, light-absorbing, etc., and gas-sensitivity at the same time.
3. By use of an LB organic film replacing conventional spacer layer and magnetic layer, devices are made lighter, thinner, easier to portable than before, and easier to be processed to obtain devices with high integration and low cost.
4. By use of an LB organic film replacing conventional spacer layer of metal oxides, total metalic magnetic layers, and other conductive layers and electrodes, materials consisting of total organic LB film can be prepared, which can be used to develop a new generation of new functional devices made of total organic LB film.

### BRIEF DESCRIPTION OF THE DRAWINGS

FIG. 1 is a room-temperature magnetic field response curve of a magnetic tunnel junction unit with a core composite film being a barrier layer prepared in embodiment 18.

### SPECIFIC MODES FOR CARRYING OUT THE INVENTION

### Embodiment 1

First, a lower electrode layer and each base layer are grown in high vacuum by magnetron sputtering technique sequentially, whose structure is Ta(5 nm)/Cu(20 nm)/Ni—Fe(5 nm)/Ir—Mn(10 nm)/Co—Fe—B(4 nm); then an LB-film of stearic acid (C₁₇H₃₅COOH) is prepared as a spacer layer in an ultraclean environment by vertical lifting method; finally, upper layers Co—Fe—B(4 nm)/Ni—Fe(5 nm)/Cu(20 nm)/Ta(5 nm) is grown under high vacuum by magnetron sputtering technique sequentially.

After the sample has been grown, a desired sample unit in certain shape and size is obtained by ultraviolet exposure with ion-beam etching, and the unit of the composite magnetic multilayer film can be applied to a device unit of magnetic-sensitive, electro-sensitive, light-sensitive or gas-sensitive sensors, or memory cell of a MRAM.

### Embodiment 2

First, a lower electrode layer and each base layer are grown in high vacuum by magnetron sputtering technique sequentially, whose structure is Ta(5 nm)/Cu(20 nm)/Ni—Fe(5 nm)/Ir—Mn(10 nm)/Co—Fe(4 nm)/Ru(0.9 nm)/Co—Fe(4 nm); then an LB film of [CH₃(CH₂)₁₄COO]₂Cd is prepared as a spacer layer in an ultraclean environment by vertical lifting method; finally, upper layers Co—Fe(4 nm)/Ru(0.9 nm)/Co—Fe(4 nm)/Cu(20 nm)/Ta(5 nm) are grown in high vacuum by magnetron sputtering technique sequentially.

After the sample has been grown, the subsequent processes are similar to the embodiment 1, so they are omitted here.

### Embodiment 3˜13

According to the method of embodiments 1 and 2, core composite films for magnetic/nonmagnetic/magnetic multilayer thin films with different LB films being the middle spacer layer (functional layer) are prepared, and the categories and characters of the LB films thereof are listed in Table 1.

TABLE 1

| | | | MR |
|---|---|---|---|
| Embodiment | the categories of LB film | character | value |
| 3 | fatty ester (C₅H₁₁COOR) | insulative | 5~50% |
| 4 | 4-octadecyl aniline | insulative | |
| | (C₁₈H₃₇—C₆H₄—NH₂) | | |
| 5 | diazafluoren-one | insulative | |
| 6 | porphyrin | insulative | |
| 7 | phthalocyaninato-polysiloxane | insulative | |
| 8 | TTF(tetrathiafulvalene)- | conductive | |
| | TCNQ(7,7′,8,8′- | | |
| | tetracyanoquinodimethane) | | |
| 9 | manganese stearate | magnetic | |
| 10 | ferrocene | magnetic | |
| 11 | doped ZnS | semiconductive | |
| 12 | TiO₂/fluorescein | semiconductive | |
| 13 | SnO₂/arachidic acid | semiconductive | |

### Embodiment 14

First, lower electrode layer and each base layer are grown in high vacuum by magnetron sputtering technique sequentially, whose structure is Ta(5 nm)/Cu(20 nm)/Ni—Fe(5 nm)/Ir—Mn(10 nm)/; then a layer of manganese stearate is prepared as a pinned magnetic layer in an ultraclean environment by vertical lifting method, subsequently, an LB-film of stearic acid (C₁₇H₃₅COOH) is grown on the layer as a spacer layer; then a layer of manganese stearate is grown as a free magnetic layer; finally, upper layers Cu(20 nm)/Ta(5 nm) are grown under high vacuum by magnetron sputtering technique sequentially.

### Embodiment 15

First, lower electrode layer and each base layer are grown in high vacuum by electron-beam evaporation technique sequentially, whose structure is Ta(5 nm)/Cu(20 nm)/Ni—Fe(5 nm)/Pt—Mn(10 nm)/; then a layer of ferrocene is prepared as a pinned magnetic layer in an ultraclean environment by vertical lifting method, subsequently, an LB film of 4-octadecyl aniline is grown on the layer as a spacer layer; then a layer of ferrocene is grown as a free magnetic layer; finally, upper layers Cu(20 nm)/Ta(5 nm) are grown in high vacuum by electron-beam evaporation technique sequentially.

### Embodiment 16

First, lower electrode layer and each base layer are grown in high vacuum by pulsed laser deposition technique sequentially, whose structure is Ta(5 nm)/Cu(20 nm)/Ni—Fe(5 nm)/Fe—Mn(10 nm)/Co—Fe—B(4 nm); then a layer of [CH₃(CH₂)₁₄COO]₂Cd is prepared as a first spacer layer in an ultraclean environment by vertical lifting method; subsequently, a layer of ferrocene is grown as a free magnetic layer; then a layer of [CH₃(CH₂)₁₄COO]₂Cd is prepared as a second spacer layer by vertical lifting method; finally, upper layers Co—Fe—B(4 nm)/Fe—Mn(10 nm)/Ni—Fe(5 nm)/Cu(20 nm)/Ta(5 nm) are grown in high vacuum by pulsed laser deposition technique sequentially.

### Embodiment 17

A magnetic field sensor comprises four single magnetic spin valve elements which are connected electrically with a bridge circuit, wherein the core three-layer film structure of each single magnetic spin valve element is composed of “a pinned Co—Fe magnetic layer/an LB film spacer layer of (C₁₀H₂₁)₃NCH₃Au(dmit)₂/a free Co—Fe magnetic layer”. In this core structure, the direction of the easy axis of the pinned magnetic layer and the direction of the easy axis of the free layer can form a certain angle, for example 90 degree. These spin valve elements are formed on the same wafer by lithography. The input signal of the bridge circuit may take a constant current mode, while output voltage of the bridge circuit becomes a scale for magnetic field or magnetic gradient.

### Embodiment 18

First, lower electrode layer and each base layer are grown in high vacuum by magnetron sputtering technique sequentially, whose structure is Ta(5 nm)/Cu(20 nm)/Ni—Fe(5 nm)/Ir—Mn(12 nm)/Co—Fe—B(4 nm); then an LB film of fatty acid CF₃(CF₂)₇(CH₂)₄COOH is prepared as a spacer layer in an ultraclean environment by vertical lifting method; finally, upper layers Co—Fe—B(4 nm)/Ni—Fe(5 nm)/Cu(20 nm)/Ta(5 nm) are grown in high vacuum by magnetron sputtering technique sequentially.

After the sample has been grown, a tunnel junction unit with size of 5×10 μm² is obtained by ultraviolet optical lithography with ion-beam etching.

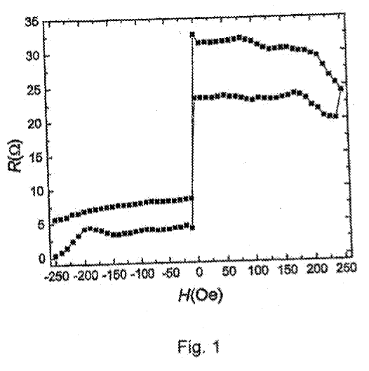

FIG. 1 shows a typical room-temperature magnetic field response curve for said magnetic tunnel junction unit with an LB film being a barrier layer. At room temperature, the tunneling magnetoresistance (TMR) is about 26.1% under external DC bias voltage of 1 mV. The value of its tunneling magnetoresistance is no less than that of the conventional magnetic tunnel junction unit with Al₂O₃ being barrier layer, moreover, it presents very small coercive force at room temperature and can meet the needs of practicability.

What is claimed is:

1. A core composite film for magnetic/nonmagnetic/magnetic multilayer thin film, comprising a free magnetic layer, a spacer layer and a pinned magnetic layer, wherein said spacer layer is an LB film.

2. A core composite film for magnetic/nonmagnetic/magnetic multilayer thin film as claimed in claim 1, is characterized in that: said LB film of the spacer layer is an organic film made of materials, the said materials include insulative, conductive or semiconductive materials.

3. A core composite film for magnetic/nonmagnetic/magnetic multilayer thin film as claimed in claim 2, is characterized in that: said insulative materials are stearic acid, ferrum hydroxyl distearate, silver stearate, leuco cyanine stearate, coumarin stearate, acidic ferrum stearate, octadecenoic acid, cetyl trimethyl ammonium bromide, fatty alcohol CₙH₂ₙ₊₁OH, fatty ester CₙH₂ₙ₊₁COOR, fatty acid amide CₙH₂ₙ₊₁CONH₂, fatty alkyl nitrile CₙH₂ₙ₊₁C≡N or fatty acid CF₃(CF₂)₇(CH₂)ₙCOOH, wherein n=2, 4, or 6.

4. A core composite film for magnetic/nonmagnetic/magnetic multilayer thin film as claimed in claim 2, is characterized in that: said insulative materials include simply substituted aromatic compound, functional complex, amphiphilic polymer, non-amphiphilic polymer, fullerene, porphyrin, phthalocyanine-like or lecithin-like compounds, pigment, peptide, protein or other biomolecules.

5. A core composite film for magnetic/nonmagnetic/magnetic multilayer thin film as claimed in claim 4, is characterized in that: said simply substituted aromatic compound is p-substituted benzene derivative R—C₆H₆—X, wherein R is C₁₈H₃₇, C₁₆H₃₃, C₁₄H₂₉, OC₁₈H₃₇, or NHC₁₈H₃₇; X is NH₂, OH, COOH, or NHNO₂;
Said functional complex is β-diketone rare earth complex, diazafluoren-one, 8-hydroxyquinoline, copper o-phthalonitrile, bilirubin, heme, or lipoic acid ester;
Said amphiphilic polymer is polyethylene family, polypropylene family, polymethacrylate family, polybutadiene family, or polyvinyl acetate family;
Said non-amphiphilic polymer is poly(3-alkylthiophene) or polyimide;
Said lecithin-like compound is phosphatidyl ethanolamine or phosphatidylcholine;
Said pigment is iron porphyrin, chlorophyllous pigment, or carotenoid;
Said other biomolecule is purple membrane or soya bean lecithin.

6. A core composite film for magnetic/nonmagnetic/magnetic multilayer thin film as claimed in claim 2, is characterized in that: said conductive materials include charge transfer compounds with amphiphilic character, amphiphilic conjugated polymer based on polypyrrole framework, polythiophene or polyacetylene.

7. A core composite film for magnetic/nonmagnetic/magnetic multilayer thin film as claimed in claim 6, is characterized in that: said charge transfer compounds with amphiphilic character are tetrathiafulvalene-7,7′,8,8′-tetracyanoquinodimethane, (TMTSF)₂(PF)₂ or transition metal complex M(dmit)₂, wherein M=Ni, Pb, Pt, Au; said polythiophene is poly(3-hexylthiophene) or poly(3-octylthiophene).

8. A core composite film for magnetic/nonmagnetic/magnetic multilayer thin film as claimed in claim 2, is characterized in that: said semiconductive materials are TiO₂/fluorescein, or SnO₂/arachidic acid, or doped ZnS.

9. A core composite film for magnetic/nonmagnetic/magnetic multilayer thin film, comprising a free magnetic layer, a spacer layer and a pinned magnetic layer, and is characterized in that: said free magnetic layer, spacer layer and pinned magnetic layer are all LB film.

10. A core composite film for magnetic/nonmagnetic/magnetic multilayer thin film as claimed in claim 9, is characterized in that: said LB film of the spacer layer is an organic film made of insulative, or conductive or semiconductive materials.

11. A core composite film for magnetic/nonmagnetic/magnetic multilayer thin film as claimed in claim 10, is characterized in that: said insulative materials include stearic acid, ferrum hydroxyl distearate, silver stearate, leuco cyanine stearate, coumarin stearate, acidic ferrum stearate, octadecenoic acid, cetyl trimethyl ammonium bromide, fatty alcohol CₙH₂ₙ₊₁OH, fatty ester CₙH₂ₙ₊₁COOR, fatty acid amide CₙH₂ₙ₊₁CONH₂, fatty alkyl nitrile CₙH₂ₙ₊₁C≡N or fatty acid CF₃(CF₂)₇(CH₂)ₙCOOH, wherein n=2, 4, or 6.

12. A core composite film for magnetic/nonmagnetic/magnetic multilayer thin film as claimed in claim 10, is characterized in that: said insulative materials include simply substituted aromatic compound, functional complex, amphiphilic polymer, non-amphiphilic polymer, fullerene, porphyrin, phthalocyanine-like or lecithin-like compound, pigment, peptide, protein or other biomolecules.

13. A core composite film for magnetic/nonmagnetic/magnetic multilayer thin film as claimed in claim 12, is characterized in that: said simply substituted aromatic compound is p-substituted benzene derivative R—C₆H₆—X, wherein R is C₁₈H₃₇, C₁₆H₃₃, C₁₄H₂₉, OC₁₈H₃₇, or NHC₁₈H₃₇; X is NH₂, OH, COOH, or NHNO₂;
Said functional complex is β-diketone rare earth complex, diazafluoren-one, 8-hydroxyquinoline, copper o-phthalonitrile, bilirubin, heme, or lipoic acid ester;
Said amphiphilic polymer is polyethylene family, polypropylene family, polymethacrylate family, polybutadiene family, or polyvinyl acetate family;
Said non-amphiphilic polymer is poly(3-alkylthiophene) or polyimide;
Said lecithin-like compound is phosphatidyl ethanolamine or phosphatidylcholine;
Said pigment is iron porphyrin, chlorophyllous pigment, or carotenoid;
Said other biomolecule is purple membrane or soya bean lecithin.

14. A core composite film for magnetic/nonmagnetic/magnetic multilayer thin film as claimed in claim 10, is characterized in that: said conductive materials include charge transfer compounds with amphiphilic character, amphiphilic conjugated polymer based on polypyrrole framework, polythiophene or polyacetylene.

15. A core composite film for magnetic/nonmagnetic/magnetic multilayer thin film as claimed in claim 14, which is characterized in that: said charge transfer compounds with amphiphilic character are tetrathiafulvalene-7,7′,8,8′-tetracyanoquinodimethane, (TMTSF)₂(PF)₂ or transition metal complex M(dmit)₂, wherein M=Ni, Pb, Pt, Au; said polythiophene is poly(3-hexylthiophene) or poly(3-octylthiophene).

16. A core composite film for magnetic/nonmagnetic/magnetic multilayer thin film as claimed in claim 10, is characterized in that: said semiconductive materials include TiO₂/fluorescein, SnO₂/arachidic acid, or doped ZnS.

17. A core composite film for magnetic/nonmagnetic/magnetic multilayer thin film as claimed in claim 9, is characterized in that: said LB films of the pinned magnetic layer and the free magnetic layer are organic films made of magnetic materials.

18. A core composite film for magnetic/nonmagnetic/magnetic multilayer thin film as claimed in claim 17, is characterized in that: said magnetic materials include manganese stearate, ferrocene, or γ-Fe₂O₃ ultrafine powder/stearic acid.

19. Use of core composite film for magnetic/nonmagnetic/magnetic multilayer thin film as claimed in claims 1˜18 in magnetic spin valve sensor or magnetic random access memory.
